(19) United States
(12) Patent Application Publication
(10) Pub. No.: US 2025/0148330 A1
(43) Pub. Date: May 8, 2025

(54) METHOD AND APPARATUS FOR SIMULATING QUANTUM CIRCUIT, COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Weitang LI, Shenzhen (CN)

(73) Assignee: TENCENT TECHNOLOGY (SHENZHEN) COMPANY LIMITED, Shenzhen (CN)

(21) Appl. No.: 19/013,142

(22) Filed: Jan. 8, 2025

Related U.S. Application Data
(63) Continuation of application No. PCT/CN2023/098652, filed on Jun. 6, 2023.

(30) Foreign Application Priority Data
Jan. 30, 2023 (CN) 202310113388.5

(51) Int. Cl. G06N 10/20; G06N 10/60

(52) U.S. Cl. CPC G06N 10/20; G06N 10/60

(57) ABSTRACT

The present disclosure discloses a method and apparatus for simulating a quantum circuit, a computer device, a storage medium, and a program product. The method includes: acquiring a polynomial by converting a unitary coupled-cluster (UCC) factor, wherein: an exponential part of the UCC factor comprises an anti-hermitian excitation operator G, and the polynomial comprises a linear term of the G and a quadratic term of the G; acquiring N UCC factors for constructing the UCC quantum circuit, N being an integer greater than 1; acquiring a wave function for representing a quantum state of an object; and obtaining a result wave function by performing operation in the form of the polynomial for each UCC factor in the N UCC factors on the wave function, wherein the result wave function represents the quantum state of the object after quantum simulation with the UCC quantum circuit.

### RELATED APPLICATION

This application is a continuation application of PCT Patent Application No. PCT/CN2023/098652, filed on Jun. 6, 2023, which claims priority to Chinese Patent Application No. 202310113388.5, filed on Jan. 30, 2023, both of which are incorporated herein by reference in their entireties.

### FIELD OF THE TECHNOLOGY

The present disclosure relates to the field of quanta, and in particular to, a method and apparatus for a quantum circuit, a computer device, a storage medium, and a program product.

### BACKGROUND OF THE DISCLOSURE

A quantum circuit is a representation of a quantum universal computer, and represents the hardware implementation of a corresponding quantum algorithm/program under a quantum gate model. The quantum circuit acts on a quantum state to obtain a new quantum state and complete quantum computation. The quantum circuit including an adjustable quantum gate control parameter is called as a parameterized quantum circuit (PQC) or a variational quantum circuit. For example, a unitary coupled-cluster (UCC) quantum circuit belongs to a special PQC, and is mainly used for molecular system chemical property quantum computation.

Quantum simulation is to simulate the motion and evolution process of a quantum system by using a quantum computer. In the related art, classical simulation solutions aiming at the UCC quantum circuit are all based on an idea of faithfully simulating the quantum circuit. During quantum circuit realization, a UCC factor needs to be decomposed into a series of quantum gates. The UCC factor is a constitutive factor in the UCC quantum circuit, i.e., e^{θ}^{ᵢ}^{G}^{ᵢ} The whole UCC quantum circuit is obtained by multiplying the UCC factors.

The UCC factors may be efficiently realized on the quantum circuit, but the UCC factors need exponential operation, the computation amount is great, and the simulation on a classical computer is difficult. How to effectively realize the simulation of the UCC quantum circuit is an urgent problem to be solved at present.

The present disclosure describes embodiments for determining a target image region of a target object in a target image, addressing at least one of the problems/issues discussed above, improving quantum simulation efficiency and/or quantum computation precision, and/or reducing the operation complexity during simulation.

### SUMMARY

In order to solve the above technical problems, embodiments of the present disclosure provide a method and apparatus for simulating a quantum circuit, a computer device, a storage medium, and a program product, the quantum simulation efficiency is effectively improved, and an effect of fast and conveniently determining a quantum state of an object corresponding to a unitary coupled-cluster (UCC) quantum circuit is achieved.

The present disclosure describes a method for simulating a unitary coupled-cluster (UCC) quantum circuit. The method may be performed by a computer device, and the computer device includes a memory storing instructions and a processor in communication with the memory. The method includes acquiring a polynomial by converting a UCC factor, wherein: an exponential part of the UCC factor comprises an anti-hermitian excitation operator G, and the polynomial comprises a linear term of the G and a quadratic term of the G; acquiring N UCC factors for constructing the UCC quantum circuit, N being an integer greater than 1; acquiring a wave function for representing a quantum state of an object; and obtaining a result wave function by performing operation in the form of the polynomial for each UCC factor in the N UCC factors on the wave function, wherein the result wave function represents the quantum state of the object after quantum simulation with the UCC quantum circuit.

The present disclosure describes an apparatus for simulating a unitary coupled-cluster (UCC) quantum circuit. The apparatus includes a memory storing instructions; and a processor in communication with the memory. When the processor executes the instructions, the processor is configured to cause the apparatus to perform: acquiring a polynomial by converting a UCC factor, wherein: an exponential part of the UCC factor comprises an anti-hermitian excitation operator G, and the polynomial comprises a linear term of the G and a quadratic term of the G; acquiring N UCC factors for constructing the UCC quantum circuit, N being an integer greater than 1; acquiring a wave function for representing a quantum state of an object; and obtaining a result wave function by performing operation in the form of the polynomial for each UCC factor in the N UCC factors on the wave function, wherein the result wave function represents the quantum state of the object after quantum simulation with the UCC quantum circuit.

The present disclosure describes a non-transitory computer-readable storage medium, storing computer-readable instructions for simulating a unitary coupled-cluster (UCC) quantum circuit. The computer-readable instructions, when executed by a processor, are configured to cause the processor to perform: acquiring a polynomial by converting a UCC factor, wherein: an exponential part of the UCC factor comprises an anti-hermitian excitation operator G, and the polynomial comprises a linear term of the G and a quadratic term of the G; acquiring N UCC factors for constructing the UCC quantum circuit, N being an integer greater than 1; acquiring a wave function for representing a quantum state of an object; and obtaining a result wave function by performing operation in the form of the polynomial for each UCC factor in the N UCC factors on the wave function, wherein the result wave function represents the quantum state of the object after quantum simulation with the UCC quantum circuit.

Various embodiments of the present disclosure disclose the following technical solutions:

In one aspect, an embodiment of the present disclosure provides a method for simulating a quantum circuit, applied to a computer device and including:

acquiring a polynomial obtained by converting a UCC factor, an exponential part of the UCC factor including an anti-hermitian excitation operator G, and the polynomial including a linear term and a quadratic term of the G;
acquiring N UCC factors for constructing a UCC quantum circuit, N being an integer greater than 1;
acquiring a wave function used for representing a quantum state of an object; and
performing quantum simulation on the UCC quantum circuit according to the wave function and the N UCC factors to obtain a result wave function, the quantum simulation being used for performing operation in the form of the polynomial on each UCC factor and the wave function, and the result wave function being used for representing the quantum state of the object simulated via the UCC quantum circuit.

In another aspect, an embodiment of the present disclosure provides an apparatus for simulating a quantum circuit, including an acquisition unit, a determining unit, and a simulation unit,
the acquisition unit being configured to acquire a polynomial obtained by converting a UCC factor, an exponential part of the UCC factor including an anti-hermitian excitation operator G, and the polynomial including a linear term and a quadratic term of the G;
the determining unit being configured to acquire N UCC factors for constructing a UCC quantum circuit, and acquire a wave function used for representing a quantum state of an object corresponding to the UCC quantum circuit, N being an integer greater than 1; and
the simulation unit being configured to perform quantum simulation on the UCC quantum circuit according to the wave function and the N UCC factors to obtain a result wave function, the quantum simulation being used for performing operation in the form of the polynomial on each UCC factor and the wave function, and the result wave function being used for representing the quantum state of the object simulated via the UCC quantum circuit.

In another aspect, an embodiment of the present disclosure provides a computer device, including a processor and a memory,
the memory being configured to store a program code and transmit the program code to the processor; and
the processor being configured to perform, based on an instruction in the program code, the method described in the above aspect.

In another aspect, an embodiment of the present disclosure provides a computer-readable storage medium, configured to store a computer program, the computer program being configured to perform the method described in the above aspect.

In another aspect, an embodiment of the present disclosure provides a computer program product, including an instruction, and causing a computer to perform the above method when running on the computer.

From the above technical solutions, the polynomial obtained by converting the UCC factor in the exponential form includes the linear term and the quadratic term of the G, the wave function used for representing the quantum state of the object corresponding to the UCC quantum circuit to be simulated and N UCC factors for representing the UCC quantum circuit are acquired, during the quantum simulation aiming at the circuit according to the wave function and the UCC factors, operation is performed in the form of the polynomial on each UCC factor and the wave function, and finally, the result wave function is obtained after quantum simulation. In the above operation process, the polynomial is converted from the exponential form to the linear term and the quadratic term of the G. Compared with the operation in the exponential form, it significantly reduces the operation complexity of the wave function and the UCC factors in quantum simulation, the UCC factor can be used for quantum simulation without quantum gate decomposition, the quantum simulation efficiency is effectively improved, and the effect of fast and conveniently determining the quantum state of the object corresponding to the UCC quantum circuit is achieved.

### BRIEF DESCRIPTION OF THE DRAWINGS

To describe the technical solutions in embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other drawings from these accompanying drawings without creative efforts.

FIG. 1 is a schematic diagram of a quantum circuit obtained after quantum gate decomposition on a UCC factor.

FIG. 2 is a schematic diagram of a quantum circuit simulation scenario provided by an embodiment of the present disclosure.

FIG. 3 is a method flow chart of a method for simulating a quantum circuit provided by an embodiment of the present disclosure.

FIG. 4 is a schematic diagram provided by an embodiment of the present disclosure.

FIG. 5 is a schematic diagram of a wave function, expressed in a configuration space, of a chemical molecule provided by an embodiment of the present disclosure.

FIG. 6 is a schematic diagram of realizing operator G and wave function operation through vector feature rearrangement and phase conversion provided by an embodiment of the present disclosure.

FIG. 7 is an effect comparison diagram in a quantum simulation example provided by an embodiment of the present disclosure.

FIG. 8 is an apparatus structure diagram of an apparatus for simulating a quantum circuit provided by an embodiment of the present disclosure.

FIG. 9 is a structure diagram of a terminal device provided by an embodiment of the present disclosure.

FIG. 10 is a structure diagram of a server provided by an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all the possible embodiments, and can be combined with each other without conflict.

Unless otherwise defined, meanings of all technical and scientific terms used herein are the same as those usually understood by a person skilled in the art to which the present disclosure belongs. Terms used herein are merely intended to describe the embodiments of the present disclosure, but are not intended to limit the present disclosure.

The following describes the embodiments of the present disclosure with reference to the accompanying drawings.

Unless otherwise defined, meanings of all technical and scientific terms used herein are the same as those usually understood by a person skilled in the art to which the present disclosure belongs. Terms used herein are merely intended to describe the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

1) Quantum circuit is a representation of a quantum universal computer, and represents the hardware implementation of a corresponding quantum algorithm/program under a quantum gate model. The quantum circuit acts on a quantum state to obtain a new quantum state and complete quantum computation. The quantum circuit including an adjustable quantum gate control parameter is called as a parameterized quantum circuit (PQC) or a variational quantum circuit. For example, a unitary coupled-cluster (UCC) quantum circuit belongs to a special PQC, and is mainly used for molecular system chemical property quantum computation.

2) Quantum simulation is to simulate the motion and evolution process of a quantum system by using a quantum computer. A UCC quantum circuit processing result: a result wave function may be fast simulated through quantum simulation.

3) Quantum computation is a computation mode of fast completing a computation task by using properties of quantum state superposition and entanglement, etc.

4) Qubit is a bearing form of quantum information. In quantum computation, the qubit is used as the unit of the quantum information. The qubit is similar to the classical bit, but is added with the quantum features of physical atoms.

5) Quantum gate is a basic quantum circuit for operating a small number of qubits. The quantum gate is the basis of the quantum circuit, and their relationship is like the relationship between a logical gate and a digital circuit. The quantum gate operates by aiming one or two qubits, the quantum gate operating by aiming at one qubit is a single-qubit gate, and the quantum gate operating by aiming at two qubits is a double-qubit gate. Some quantum gates and their definitions will be shown in Table 1 below.

TABLE 1
Quantum gates

| Quantum gate | Definition | Parameter |
|---|---|---|
| Rotation gate R_{Y}(θ) | $[ \begin{matrix}cos ( θ / 2 ) & - sin ( θ / 2 ) \\ sin ( θ / 2 ) & cos ( θ / 2 )\end{matrix} ]$ | θ ∈ [symbol] |
| Rotation gate R_{z}(θ) | $[ \begin{matrix}{e}^{- i θ / 2} & \\ & {e}^{i θ / 2}\end{matrix} ]$ | θ ∈ [symbol] |
| R quantum gate R(θ) | $[ \begin{matrix}1 & \\ & {e}^{i θ}\end{matrix} ]$ | θ ∈ [symbol] |
| Hadamard gate (H) | $\frac{1}{\sqrt{2}} [ \begin{matrix}1 & 1 \\ 1 & - 1\end{matrix} ]$ | None |
| Phase gate S | $[ \begin{matrix}1 & \\ & i\end{matrix} ]$ | None |
| CNOT (Controlled- | CNOTⱼⁱ\|x [symbol] ᵢ\|y [symbol] ⱼ = \|x [symbol] ᵢ\|x ⊕ y [symbol] ⱼ | i and j, which are |
| NOT) gate | | qubits |

6) Quantum state: It is a system quantum state, and may be expressed as a linear combination of each basis state. For example, for a 1-qubit quantum system, all possible basis states are 0 and 1, while for a three-qubit system, all possible basis states are totally 8 including 000, 001, 010, 011, 100, 101, 110, and 111. Supposed these basis states are {ϕᵢ}, the quantum state may be expressed as Σᵢ cᵢ ϕᵢ and cᵢ is a linear combination coefficient.

7) Full qubit space: It is a space formed by all basis states of all qubits in the system. If the number of the qubits is N, the quantity of all basis states is 2^{N}, and the size of the full qubit space is 2^{N}.

8) UCC quantum circuit: It is a special PQC, is mainly used for molecular system chemical property quantum computation, and may be mathematically expressed as ΠHᵢe^{θ}^{ᵢ}^{G}^{ᵢ}, θᵢ, is a parameter, and Gᵢ is an anti-hermitian excitation operator. The UCC quantum circuit substantially simulates the quantum state of the chemical system. Therefore, the energy of the molecular or material system may be obtained through optimizing θᵢ based on a variation principle, and other chemical properties may be further calculated after the optimum θᵢ is obtained.

9) UCC factor: It is a constitutive factor in a UCC quantum circuit, an i^{th} UCC factor is recorded as e^{θ}^{ᵢ}^{G}^{ᵢ}, and the whole UCC quantum circuit is obtained by multiplying a plurality of UCC factors.

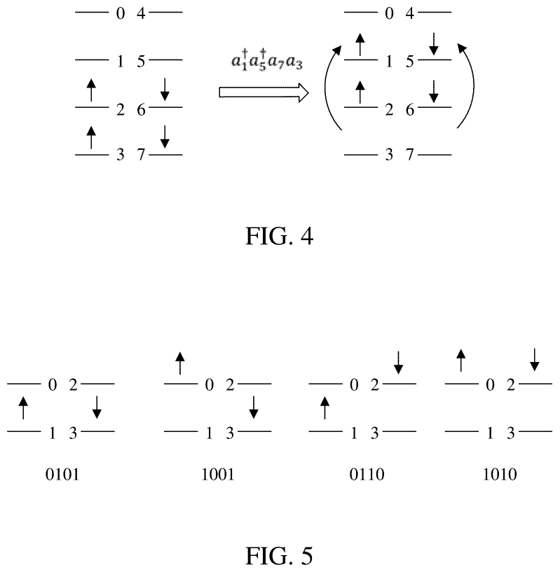

10) Creation operator and annihilation operator: As shown in FIG. 4, a creation operator and an annihilation operator are operators acting on the quantum state or the configuration, are recorded as aᵢ^{†} and aᵢ, and may create or annihilate a particle at the i^{th} qubit.

11) Wave function: In broadly speaking, it is a quantum state, and in a narrow sense, it is expression of the quantum state in coordinate representation.

In the related art, classical simulation solutions aiming at the UCC quantum circuit are all based on an idea of faithfully simulating the quantum circuit. During quantum circuit realization, a UCC factor needs to be decomposed into a series of quantum gates. The UCC factor is a constitutive factor in the UCC quantum circuit, i.e., e^{θ}^{ᵢ}^{G}^{ᵢ}. The whole UCC quantum circuit is obtained by multiplying the UCC factors. The UCC factor may be efficiently realized on the quantum circuit. However, during classical computer simulation, the action result of each quantum gate on the quantum state may be realized as a multiplication of a matrix and a vector, so the matrix multiplications required by classical simulation will be more if the quantum gates are more, and the classical computer simulation difficulty may be caused by the huge computation amount.

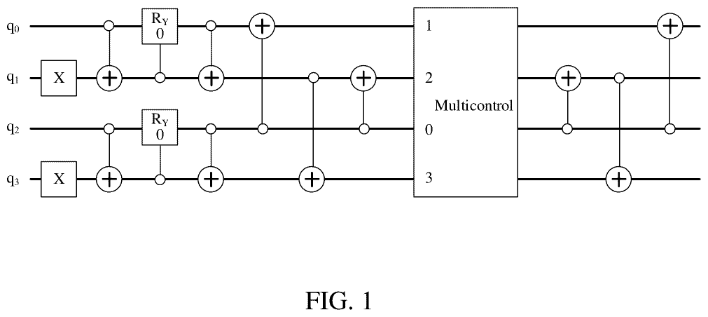

FIG. 1 shows a relatively simple quantum gate decomposition result. That is, FIG. 1 shows the quantum circuit obtained after quantum gate decomposition on the UCC factor. In the figure, q0-q3 all represent qubits. Square or round nodes in FIG. 1 are quantum gates. For example, a square x indicates a processing mode similar to a NOT gate, and a round symbol “†” represents a processing logic similar to a controlled-not gate, etc.

During classical simulation, the action result of each quantum gate on the quantum state may be realized as a multiplication of the matrix and the vector. Thus, matrix multiplications required by classical simulation will be more if the quantum gates are more.

Therefore, by quantum gate decomposition, the computation amount and the computation complexity caused by the UCC factors are considerable.

Therefore, an embodiment of the present disclosure provides a method for simulating a quantum circuit. The quantum simulation efficiency may be effectively improved. An effect of fast and conveniently determining the quantum state of the object corresponding to the UCC quantum circuit is achieved.

The method for simulating a quantum circuit provided by the embodiment of the present disclosure may be implemented through a computer device. The computer device may be a terminal device or a server. The server may be an independent physical server, a server cluster or a distributed system formed by a plurality of physical servers, or a cloud server that provides a cloud computing service. The terminal device includes but is not limited to a mobile phone, a computer, an intelligent voice interaction device, a smart home appliance, an on board terminal, an aircraft, and the like. The terminal device may be connected directly or indirectly to the server in a wired or wireless communication manner, which is not limited in the embodiment of the present disclosure.

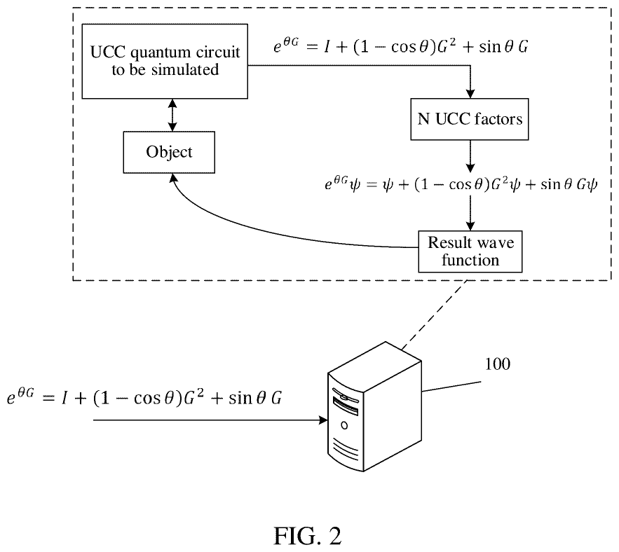

FIG. 2 is a schematic diagram of a quantum circuit simulation scenario provided by an embodiment of the present disclosure. In the embodiment of the present disclosure, a server 100 is used as the above computer device for illustration.

In order to reduce the operation complexity of quantum simulation, the server 100 may acquire a polynomial obtained by converting a UCC factor in an exponential form. Through the described conversion, G of the exponential part in the UCC factor is converted into a linear term and a quadratic term of the G in the polynomial. For example, the form of the polynomial in FIG. 1 is as follows:

$${e}^{θ G} = I + ( 1 - cos θ ) {G}^{2} + sin θ G \qquad ( 1 )$$

in the polynomial, I is an identity matrix, e^{θG} is the UCC factor, θ is a parameter, G is the anti-hermitian excitation operator, (1−cos θ)G² is a quadratic term, and sin θ G is a linear term.

The server 100 determines a wave function for representing the quantum state of an object corresponding to the circuit and N UCC factors for representing the circuit according to the UCC quantum circuit to be simulated. The UCC quantum circuit is set by aiming at the object.

During quantum simulation on the circuit according to the wave function and the N UCC factors, the server 100 performs operation in the form of the polynomial on each UCC factor and the wave function. A result wave function is finally obtained through quantum simulation. The result wave function may be used for representing the quantum state of the object simulated via the UCC quantum circuit.

The operation in the form of the polynomial on each UCC factor and the wave function may be in the following form:

$${e}^{θ G} ψ = ψ + ( 1 - cos θ ) {G}^{2} ψ + sin θ G ψ \qquad ( 2 )$$

in the formula, ψ is the wave function.

Through polynomial conversion, the G is converted from the exponential part to the linear term and the quadratic term. The operation complexity of the wave function and the UCC factors in quantum simulation is significantly reduced. The UCC factor can be used for quantum simulation without quantum gate decomposition. The quantum simulation efficiency is effectively improved. The effect of fast and conveniently determining the quantum state of the object corresponding to the UCC quantum circuit is achieved.

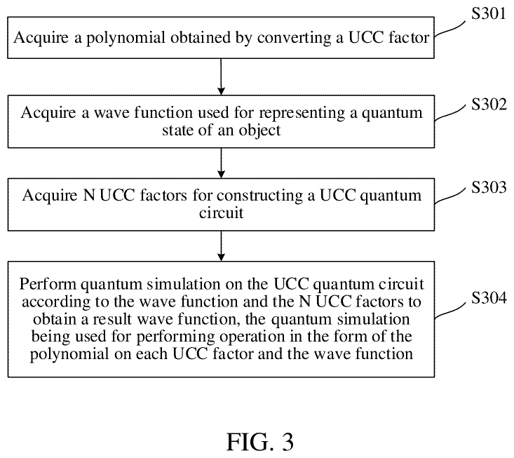

FIG. 3 is a method flow chart of a method for simulating a quantum circuit provided by an embodiment of the present disclosure. In this embodiment, the server is used as the above computer device for illustration. The method includes the following operations:

S301: Acquire a polynomial obtained by converting a UCC factor.

The UCC factor is a constitutive factor in a UCC quantum circuit, i.e., e^{θ}^{ᵢ}^{G}^{ᵢ}. The whole UCC circuit is obtained by multiplying N UCC factors. The exponential part of the UCC factor includes an anti-hermitian excitation operator G, and the G is a relatively complicated operator, so the UCC factor may be efficiently realized on the quantum circuit, but the classical computer simulation is difficult.

In the embodiment of the present disclosure, in order to improve the quantum simulation efficiency and reduce the operation complexity during simulation, the server may convert the UCC factor to obtain a polynomial, or a UCC factor converted polynomial may be directly obtained. This polynomial includes a linear term and a quadratic term of the G. The UCC factor is converted from the exponential form to the polynomial. Thus, during subsequent quantum simulation, the operation complexity during UCC factor multiplication in quantum computation is significantly reduced, and the quantum simulation speed may be effectively accelerated.

The quantum computation is a computation mode based on quantum logics, a basic unit for storing data is qubit, and the qubit is a basic unit of quantum computation.

A classical computer (by taking a personal computer (PC) as an example) includes a host, a display, a mouse, a keyboard, etc. The host generally includes components such as a mainboard, a power supply, a chip, a video card, and a hard disk. The machine is small in occupied space, and may be used in a normal-temperature environment. A quantum computer (by taking a superconducting quantum computer as an example) mainly includes three parts: a quantum chip, a control system, and a low-temperature system. The quantum chip is configured for computation. The control system is configured to generate, collect, control, and process precise signals required by the quantum chip. The low-temperature system is configured to provide a stable running environment, including an ultra-low temperature, external electromagnetic shielding and isolation, etc., for the quantum chip. The size of the quantum computer is very great. A special place generally needs to be built for the quantum computer to operate.

The classical computer uses 0 and 1 as a basic unit of a binary system. The quantum computer may process 0 and 1 at the same time, and the system may be in a linear superposition state of 0 and 1: |ψ [symbol] =α|0 [symbol] +β|1 [symbol] , α, β represent complex probability amplitudes of the system on 0 and 1, and their modular squares |α|², |β|² respectively represent probabilities at 0 and 1.

In a possible implementation, the polynomial is specifically as follows:

$${e}^{θ G} = I + ( 1 - cos θ ) {G}^{2} + sin θ G . \qquad ( 3 )$$

In the polynomial, I is an identity matrix, e^{θG} is the UCC factor, θ is a parameter, and G is the anti-hermitian excitation operator.

As mentioned above, in techniques related to quantum computation, a great number of matrix multiplications are needed to simulate the UCC factors. The number of the matrix multiplications is about at the O(N) magnitude. A constant coefficient is very great. The computation amount is great. In the embodiment of the present disclosure, the UCC factor is subjected to polynomial expansion, and the number of the needed matrix multiplications may be lowered to a constant magnitude, i.e., twice, so that the computation amount of the quantum simulation is greatly reduced.

S302: Acquire a wave function used for representing a quantum state of an object.

The wave function acquired in S302 is also called as an initial wave function. The initial wave function expresses a quantum state of the object, and may be determined according to the specific object. For example, when the object is a chemical molecule, it may be a Hartree-Fock state in the chemical field, its form is simple, and a vector only with one element being 1, like [1, 0, 0, 0] generally expresses the initial quantum state.

The quantum state may be understood as a state of the object in a quantum system, and may be expressed as a linear combination of each basis state. For example, for a 1-qubit quantum system, the linear combination of all possible basis states includes 0 and 1, while for a three-qubit quantum system, the linear combination of all possible basis states totally includes 8 including 000, 001, 010, 011, 100, 101, 110, and 111. Supposed these basis states are {ϕᵢ}, the quantum state may be expressed as Σᵢ cᵢϕᵢ, and cᵢ is a linear combination coefficient.

S303: Acquire N UCC factors for constructing the UCC quantum circuit.

The UCC quantum circuit is a special PQC, may be used for molecular system chemical property quantum computation, and may be mathematically expressed as Πᵢ e^{θ}^{ᵢ}^{G}^{ᵢ} ψ, θᵢ is a parameter, Gᵢ is an anti-hermitian excitation operator, and ψ is a wave function. The UCC quantum circuit may be used for simulating the quantum state of the object (for example, a chemical molecule) of the chemical system. Therefore, the energy of the molecular or material system may be obtained through optimizing θᵢ based on a variation principle, and other chemical properties may be further calculated after the optimum θᵢ is obtained.

By aiming at different objects or different quantum computation requirements, different UCC quantum circuits. i.e., UCC quantum circuits to be simulated, may be designed. The difference of different UCC quantum circuits is mainly in the quantity of quantum states. That is, the corresponding number of quantum states is designed according to the practical computation objects or computation requirements. Through the quantum computation of the UCC quantum circuit, the quantum state of the object corresponding to the UCC quantum circuit after quantum computation may be determined.

As mentioned above, the UCC quantum circuit may be obtained by multiplying a plurality of UCC factors, so N is greater than 1. N UCC factors are acquired through following operations: All single-excitation and double-excitation operators are traversed. Specifically, N⁴ UCC factors are totally acquired through traversing the single-excitation and double-excitation operators of the G below and I, j, k, and 1 indexes in an expression. The wave function is used for representing the quantum state of the object simulated by the UCC quantum circuit, and specifically representing the occurrence probability of the quantum state of the object in a specific time and space.

In a possible implementation, when the object is a chemical molecule, the G may be expressed in the following form:

G=aᵢ^{†}aⱼ−aⱼ^{†}aᵢ single-excitation form, and

G=aᵢ^{†}aⱼ^{†}aₖaₗ−aₗ^{†}aₖ^{†}aⱼaᵢ double-excitation form.

In the formulas, aᵢ^{†} is an operator of a particle created at an i^{th} qubit, and is recorded as a creation operator, aⱼ is an operator of a particle annihilating at a j^{th} qubit, and is recorded as an annihilation operator, and the creation operator and the annihilation operator are both operators acting on the quantum state or configuration.

For example, as shown in FIG. 4, numbers 0-7 respectively represent 8 spin orbitals. Each spin orbital may be expressed through a qubit The spin orbital where an arrow is located expresses that this spin orbital includes a particle. The direction of the arrow indicates the spin direction of the particle. After indication operation of an operator aᵢ^{†}a₅^{†}a₇a₃ in the G, a particle is created on each of 1^{st} and 5^{th} spin orbitals, and particles originally on the 3^{rd} and 7^{th} spin orbitals are annihilated, so that the quantum state of the 8 spin orbitals is converted from a condition of the left side of FIG. 4 to a condition of the right side of FIG. 4. If the wave function is expressed through the above basis state, the quantum state (which may also be called as a basis state combination) of the condition of the left side of the FIG. 4 is 00110011, and the quantum state (which may also be called as a basis state combination) of the condition of the right side of FIG. 4 is 01100110.

Through the G in the single-excitation form or the double-excitation form, the quantum state of the chemical molecule may be adjusted in a targeted manner, and the quantum computation precision of the UCC quantum circuit is improved.

It is not limited in the embodiment of the present disclosure that the G is only in the above single-excitation form or the double-excitation form. The G may also be a more complicated expression form, for example, more expression forms such as a triple-excitation form like aᵢ^{†}aⱼ^{†}aₖ^{†}aₗaₘaₙ−aₙ^{†}aₘ^{†}aₗ^{†}aₖaⱼaᵢ.

S304: Perform quantum simulation on the UCC quantum circuit according to the wave function and the N UCC factors to obtain a result wave function, the quantum simulation being used for performing operation in the form of the polynomial on each UCC factor and the wave function.

As mentioned above, in the form of the polynomial, the operator G is converted from the exponential part where the UCC factor is originally located into the linear term and the quadratic term of the polynomial. In the operation of the polynomial and the wave function, the quantity of the required matrix multiplications is reduced to a constant magnitude, i.e., twice.

In a possible implementation, the operation in the form of the polynomial on each UCC factor and the wave function is performed as follows:

$${e}^{θ G} ψ = ψ + ( 1 - cos θ ) {G}^{2} ψ + sin θGψ . \qquad ( 4 )$$

In the formula, ψ is the wave function.

By setting i to be an integer progressively increasing from 1, and enabling i to meet i≤N−1, the operation is performed on the wave function and one UCC factor (for example, an i^{th} UCC factor in the N UCC factors) to obtain a novel wave function which may be recorded as a wave function corresponding to the (i+1)^{th} UCC factor. In combination with Formula (4) above, the wave function ψᵢ₊₁ of the (i+1)^{th} UCC factor is expressed as follows:

$${ψ}_{i + 1} = {e}^{{θ}_{i} {G}_{i}} {ψ}_{i} = {ψ}_{i} + ( 1 - cos {θ}_{i} ) {G}^{2} {ψ}_{i} + sin {θ}_{i} {G}_{i} {ψ}_{i} . \qquad ( 5 )$$

In the formula, ψᵢ is the wave function of the i^{th} UCC factor, and e^{θ}^{ᵢ}^{G}^{ᵢ} is the i^{th} UCC factor.

The operation is continuously performed on the wave function corresponding to the (i+1)^{th} UCC factor and the (i+1)^{th} UCC factor, and so on. After the operation on the wave function corresponding to the N^{th} UCC factor and the last UCC factor (i.e., the N^{th} UCC factor) is completed, the obtained wave function is recorded as a result wave function. The result wave function may be used for representing the quantum simulation result on the UCC quantum circuit.

In a possible implementation, the quantum simulation is performed as follows:

Πᵢe^{θ}^{ᵢ}^{G}^{ᵢ}ψ (6).

In the formula, e^{θ}^{ᵢ}^{G}^{ᵢ} is an i^{th} UCC factor, ψ is a wave function, a ψ obtained by operation of ψ with the i^{th} UCC factor is used for performing operation with the (i+1)^{th} UCC factor, and i≤N−1.

More specifically, it may be expressed as follows:

$${ψ}_{i + 1} = {\prod }_{i} {e}^{{θ}_{i} {G}_{i}} {ψ}_{i} . \qquad ( 7 )$$

In the formula, ψᵢ₊₁ is the wave function of the (i+1)^{th} UCC factor, and ψᵢ is the wave function of the (i+1)^{th} UCC factor. The result wave function is used for representing the quantum state of the object simulated via the UCC quantum circuit, i.e., the quantum simulation result. For example, when the object corresponding to the UCC quantum circuit is a hydrogen molecule, the result wave function may represent the quantum state of the hydrogen molecule after the quantum computation on the hydrogen molecule via the UCC quantum circuit.

Through efficient quantum simulation, the optimum parameter θᵢ aiming at the UCC quantum circuit may be fast obtained through adjustment based on quantum simulation. The parameter ψᵢ is used for representing a parameter value in the i^{th} UCC factor. Different UCC factors may have different parameter values, or all or parts of UCC factors may have the same parameter values.

Therefore, in order to reduce the operation complexity of quantum simulation, the polynomial obtained by converting a UCC factor in an exponential form may be acquired. Through the described conversion, the anti-hermitian excitation operator G of the exponential part in the UCC factor is converted into a linear term and a quadratic term of the G in the polynomial. According to the UCC quantum circuit to be simulated, the wave function for representing the quantum state of the object corresponding to the circuit and the N UCC factors for representing the circuit are determined. During quantum simulation on the circuit according to the wave function and the N UCC factors, operation is performed in the form of the polynomial on each UCC factor and the wave function, and the result wave function is finally obtained through quantum simulation. Through polynomial conversion, the UCC factor is converted from the exponential form to the linear term and the quadratic term of the G. The operation complexity of the wave function and the UCC factors in quantum simulation is significantly reduced. The UCC factor can be used for quantum simulation without quantum gate decomposition. The quantum simulation efficiency is effectively improved. The effect of fast and conveniently determining the quantum state of the object corresponding to the UCC quantum circuit is achieved.

The object corresponding to the UCC quantum circuit may relate to different fields, such as the physical field and the chemical field, and this is not limited in embodiments of the present disclosure.

In a possible implementation, when the object is a chemical molecule, the method further includes: determining a molecular energy of the chemical molecule according to quantum states of electrons in the chemical molecule represented by the result wave function. The molecule state depends on the wave function of the molecule, so that the energy of the molecule is determined by the wave function. The wave function is expressed as a vector V, the A energy operator of the molecule is expressed as a sparse matrix A, the molecular energy may be expressed as V^{T}AV, and V^{T} is a transposed matrix of the V.

The molecular energy of the chemical molecule may be obtained through different quantum states shown by the result wave function. Other chemical properties of the chemical molecule may be further calculated on this basis. Therefore, the embodiments of the present disclosure are effectively applied to quantum simulation in the chemical field, and the efficiency and practicality of the quantum simulation in the chemical field are improved.

When the object corresponding to the UCC quantum circuit is the chemical molecule, the mode of representing the wave function in a configuration space is provided by an embodiment of the present disclosure, and the storage pressure of the wave function on the server is significantly reduced.

When the object is the chemical molecule, the wave function is determined by: S11: Determine a molecular orbital corresponding to the chemical molecule and a position combination of a position capable of being occupied by electrons of the molecule in the molecular orbital. S11: Generate the wave function expressed in the configuration space according to the molecular orbital and the position combination.

Firstly, the quantum theoretical knowledge in this embodiment is shown as follows:

Molecular orbital: It is a tool for describing an electron state in the molecule system, i.e., an electron wave function. It refers to a space orbital without additional specification.

Space orbital and spin orbital: They are concepts in a chemical molecular orbital. One space orbital may accumulate two electrons with opposite spin directions. If one space orbital is artificially divided into two, each orbital may accumulate one electron, and these orbitals may be called as spin orbitals.

Full qubit space: It is a space formed by all basis states of all qubits in the system. If the number of the qubits is N, the quantity of all basis states is 2^{N}, and the size of the full qubit space is 2^{N}.

Configuration space: It is a space for describing a basis state of the chemical quantum system. It is smaller than the full qubit space. This is because: electron conservation in the chemical quantum system causes occurrence impossibility of some basis states in the full qubit space in the chemical system, and it may be ignored.

Configuration: It is a possible filling form of an electron in the molecular orbital. By considering the molecule with M electrons and N space molecular orbitals, the quantity of the upward and downward spin electrons is respectively M/2. By taking the upward spin electrons as an example, M/2 electrons totally have

$${C}_{\frac{M}{2}}^{\frac{N}{2}}$$

combination modes in the N/2 spin orbitals, and C represents a quantity of combinations. By additionally considering the downward spin electrons, the total configuration number is

$${( {C}_{\frac{M}{2}}^{\frac{N}{2}} )}^{2} .$$

Each configuration may be expressed by one qubit character string, such as 0101.

In techniques related to quantum simulation, the full qubit space provided by the wave function is stored, and the internal memory occupation is great. In the quantum simulation process of the UCC quantum circuit, the classical computer needs to store the state of the full qubit space, i.e., 2×2^{N} floating-point numbers (a reason of additionally multiplying by 2 is that a coefficient cᵢ of each state is plural). In an embodiment of the present disclosure, the quantum state of the chemical molecule corresponding to the UCC quantum circuit is expressed in the configuration space, the floating-point numbers to be stored may be reduced to

$${( {C}_{\frac{M}{2}}^{\frac{N}{2}} )}^{2} ,$$

M is the quantity of electrons, and C represents the quantity of combinations.

The reason that the quantity of the quantum states to be stored may be greatly reduced is as follows: the electron conservation in the chemical quantum system causes occurrence impossibility of some basis states of the full qubit space in the chemical system, and it may be ignored. Therefore, for the quantum simulation aiming at the chemical field, the possible configuration of the chemical molecule may be determined in a possible filling form of the electrons of the chemical molecules corresponding to the UCC quantum circuit in the molecular orbital, and the expression of the wave function for describing the possible filling form of the electrons in the chemical molecules in the molecular orbital is converted from the full qubit space into the configuration space.

By accelerating the UCC circuit simulation speed, the embodiment of the present disclosure may significantly accelerate the design and test of quantum computation chemical algorithms in the academic field and the industrial field, so that the practical application of the quantum computers and the quantum algorithms may be promoted.

As shown in FIG. 5, it shows a molecular orbital of a hydrogen molecule. The molecular orbital theory is the basis to understand the molecular system. The molecular orbital is created by atom orbitals, and each orbital may accommodate two electrons with opposite spin directions. The electrons are filled into each orbital in a sequence from low energy to high energy.

The hydrogen molecule totally has two molecular orbitals. The number of the first molecular orbital is 1, 3, the number of the second molecular orbital is 0, 2, and each number indicates one spin orbital. The hydrogen molecule has an upward spin electron and a downward spin electron in the basis state. The upward spin electron may occupy 0 and 1. The downward spin electron may occupy 3 and 2. Under such limitation, all possible electron occupations or all possible configurations are as shown in FIG. 5 which shows four possible forms of the configuration space.

Therefore, the state of the hydrogen molecule may be accurately described in the 4-dimensional configuration space. In quantum computation, one qubit is generally used for representing one spin orbital, so that the dimension of the full qubit space is 16. In fact, only 4 elements in the 16-dimensional vector are not zero, and other elements are all 0.

These 4 elements, i.e., elements 0101, 1001, 0110, and 1010 (represented through the basis state combinations, respectively shown in FIG. 5 from left to right) respectively corresponding to the configuration space are not zero.

Therefore, compared with wave function expression through the full qubit space in the related art, the wave function expression in the configuration space has the advantage that the storage space may be effectively and greatly released. For example, in the above example, if the wave function is expressed in the full qubit space, the server needs to store the 16-dimensional vector, but if the wave function is expressed in the configuration space, the server only needs to store the 4-dimensional vector.

The improvement of the anti-hermitian excitation operator G in an embodiment of the present disclosure will be continuously illustrated hereafter.

The quantum state is expressed in the configuration space, so correspondingly, various operators such as the G also need to be expressed in the configuration space, and the quantum computation efficiency in quantum simulation may be improved only in such a way. The G has a simple matrix expression in the full qubit space, and is expressed as a complicated sparse matrix in the configuration space. If the G cannot be efficiently stored and the multiplication operation, such as Gψ, of the linear term or the quadratic term of the G and the wave function cannot be realized, the efficiency cannot be improved even if the quantum state is expressed in the configuration space.

In a possible implementation, the operation in the form of the polynomial on each UCC factor and the wave function in S303 includes the following sub-operations:

S3031: Determine a first operation result determination mode of performing operation on the linear term of the G in the polynomial and the wave function, and a second operation result determination mode of performing operation on the quadratic term of the G and the wave function.

S3032: Acquire an operation result of each UCC factor and the wave function according to the first operation result determination mode and the second operation result determination mode.

The first operation result determination mode and the second operation result determination mode are used for representing the mode of obtaining the corresponding operation result. The first operation result determination mode may be determined through the rule in the operation process of the linear term of the G and the wave function. The second operation result determination mode may be determined through the rule in the operation process of the quadratic term of the G and the wave function. These rules may be change rules between the operation result and the wave function, and may also be change rules between operation intermediate results and the wave function.

Through the rules expressed by these operation result determination modes, the server may not need the practical operation during processing the operation in the form of the polynomial on each UCC factor and the wave function, and the operation result (i.e., a new wave function) may be directly deduced based on the above rules. Therefore, the expression of the G in the UCC factor in the configuration space is not needed, the two above operation result determination modes are called in the operation involved with the G and the wave function, the operation results of the wave function with the linear term of the G and the quadratic term of the G may be directly determined, and the operation result of the UCC factor and the wave function may be fast and conveniently acquired. This method does not need the server to maintain the configuration space for representing the G, and only the simple first operation result determination mode and second operation result determination mode need to be maintained, so that the storage space of the server is significantly saved, and the operation speed of the UCC factor and the wave function, i.e., the e^{θG}ψ operation speed may be effectively accelerated.

In a possible implementation, the first operation result determination mode includes once vector feature rearrangement on the wave function and once phase conversion on the wave function; and the second operation result determination mode includes once phase conversion on the wave function.

During the operation of the server on the UCC factor and the wave function, the obtained operation result is the wave function corresponding to the next UCC factor, or is the result wave function. The wave function mainly records the quantum state of the object corresponding to the UCC quantum circuit. Any one-qubit quantum state may be expressed by a possible basis state and the coefficient of the basis state.

Therefore, through the change condition of the quantum state in the wave function after each operation, the change rule of the basis state of each qubit and the coefficient of the basis state (for example, α, β in the quantum state definition described above, or modular square of α, β) described by the wave function before and after the operation may be determined. In an embodiment of the present disclosure, the change rule of the basis state of each qubit described by the wave function is recorded through vector feature rearrangement, and the change rule of the coefficient of the basis state of each qubit descried by the wave function is recorded through phase conversion.

The particle creation or annihilation guided by any one G occurs in pairs, so the vector feature rearrangement mainly marks the rearrangement rules of the basis state of each qubit in the wave function under the operation influence of the specific G after the computation on the wave function and the corresponding UCC factor. The coefficient of the basis state may also regularly change with the guidance occurrence of the G, so the phase conversion mainly represents the rearrangement rules of the coefficient of the basis state of each qubit in the wave function under the operation influence of the specific G after the computation on the wave function and the corresponding UCC factor.

The server performs classification maintenance through recording the vector feature rearrangement and the phase conversion related to the G and the wave function and through the operation with the linear term of the G and the operation with the quadratic term of the G, so that the server does not need to store the G in a configuration space form, and may realize the operation result guidance on the UCC factor and the wave function by directly storing the vector feature rearrangement and the phase conversion related to the G and the wave function, and the operation efficiency of this part of operation in the quantum simulation is significantly improved.

In order to clearly illustrate the vector feature rearrangement and the phase conversion related to the G and the wave function, specific exemplary illustration will be provided by using the G in the single-excitation form.

In a possible implementation, when the G is in the single-excitation form, in the first operation result determination mode, a phase parameter adopted by phase conversion is one of −1, 0, and 1, and in the second operation result determination mode, the phase parameter adopted by phase conversion is one of −1 and 0.

By taking the single-excitation form of the G like the following formula as an example,

$$G = {a}_{i}^{†} {a}_{j} - {a}_{j}^{†} {a}_{i}$$

how to realize Gψ in the configuration space is illustrated. In the formula, i≠j. The realization of the double-excitation operator is similar, and it is not repeated here.

During the operation in the form of the polynomial on the UCC factor and the wave function, the operation on the wave function and the linear term of the G, and the operation on the wave function and the quadratic term of the G are needed. For example, in an above possible implementation, the operation in the form of the polynomial on the UCC factor and the wave function may be expressed as follows: e^{θG}ψ=ψ+(1−cos θ)G²ψ+sin θ Gψ. In this implementation, the operation of the wave function and the linear term of the G and the operation of the wave function with the quadratic term of the G are respectively: Gψ and G²ψ.

Under the condition that the operator G is in the single-excitation form, the basis state in the configuration space may be divided into 4 types (as shown in the table below). Different effects may be respectively achieved after the G acts on these states.

| Before action of G | After action of G |
|---|---|
| Particles exist at | This coefficient of the basis |
| both i and j (11) | state is changed into 0 |
| No particle at i | Changed into a state of no particle |
| but a particle at j (10) | at j but a particle at i |
| No particle at j | Changed into a state of no particle |
| but a particle at i (01) | at i but a particle at j, and the |
| | coefficient is multiplied by −1 |
| No particle at both | This coefficient of the basis state |
| i and j (00) | is changed into 0 |

According to the above rule, realization of Gψ includes two operations:

Operation 1: Exchange the state of no particle at i but a particle at j with the state of a particle at j but no particle at i, i.e., subject the ψ vector to once vector feature rearrangement.

Operation 2: Multiply each element in the ψ vector by a phase to realize phase conversion according to the enumeration condition in the above table, possible values of the phase parameters being −1, 0, or 1.

A method for realizing G²ψ is as follows. Firstly, G² may be expressed as follows:

$${G}^{2} = - {a}_{i}^{†} {a}_{i} ( 1 - {a}_{j}^{†} {a}_{j} ) - {a}_{j}^{†} {a}_{j} ( 1 - {a}_{i}^{†} {a}_{i} )$$

The basis state in the configuration space may be divided into 2 types (as shown in the table below). Different effects may be respectively achieved after the G acts on these states.

| Before action of G² | After action of G² |
|---|---|
| A particle exists at | This coefficient of the basis state is |
| i and j (10 or 01) | changed into −1 |
| Other conditions (11 or 00) | This coefficient of the basis state is |
| | changed into 0 |

Therefore, the realization of G²ψ only needs one operation: each element in the ψ vector is multiplied by one phase to realize phase conversion, and the possible values of the phase parameters may be −1, or 0.

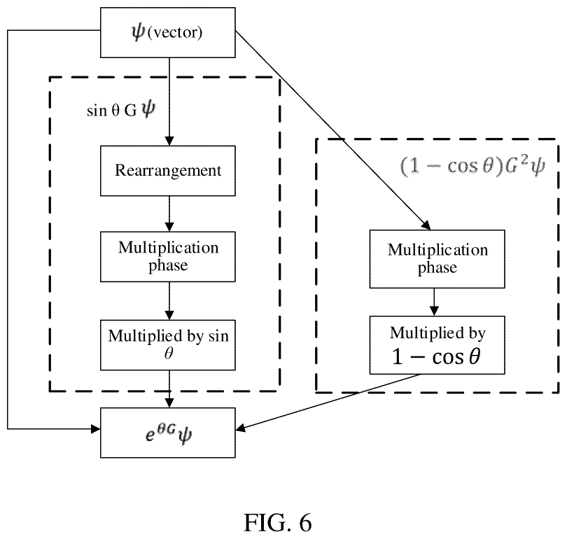

Based on the above, the operations required for realizing e^{θG}ψ are as shown in FIG. 6. The two matrix multiplications of the wave function and the G are replaced by the vector feature rearrangement and the phase conversion (for example, in a phase parameter multiplying form).

After acquiring the latest wave function in the operation, the server determines the corresponding first operation result determination mode and second operation result determination mode according to the i^{th} UCC factor corresponding to this operation. For example, when the G in the i^{th} UCC factor is in the single-excitation form, the first operation result determination mode is the rearrangement aiming at the feature vector and the multiplication phase aiming at the phase conversion, and the second operation result determination mode is the multiplication phase aiming at the phase conversion.

The server may convert out the operation result of the wave function and the linear term of the G by sequentially executing the first two operations in the left dotted box in FIG. 6, and then, the operation result is multiplied with sin θ to obtain an operation result of sin θGψ.

By executing the first operation in the right dotted box in FIG. 6, the server may convert out the operation result of the wave function and the quadratic term of the G, and then, the operation result is multiplied with (1−cos θ) to obtain the operation result of (1−cos θ)G²ψ.

Therefore, only the matrix addition operation is left for the operation on the wave function and the UCC factor, the server may fast obtain the final operation result, i.e., the new wave function (for example, the wave function for operation with the (i+1)^{th} UCC factor, or the result wave function).

The quantum simulation solution provided by the embodiments of the present disclosure may significantly accelerate the quantum simulation speed of the UCC quantum circuit, and may be applicable to a larger scale of quantum simulation of the UCC quantum circuit.

The table below shows a practical time for simulating a hydrogen chain system by using the unitary coupled-cluster singles and doubles (UCCSD) under an STO-3G basis group. Software taking part in comparison includes the quantum simulation solution of the present disclosure and some related art for quantum simulation, such as Qiskit-Nature, PennyLane, Tequila, and MindQuantum. Except for this solution, the computation speed of other related art is generally in the same magnitude, but the computation speed of MindQuantum is relatively high. Compared with MindQuantum, in systems H8 and H10, the quantum simulation solution of the present disclosure has more than 1000 times acceleration. On the other hand, the system to be simulated at the maximum extent in other related art is 20 qubits, but the quantum simulation solution of the present disclosure may complete the quantum simulation of a big quantum system of 32 qubits within an acceptable duration, and this is a task which cannot be completed by all of the related art.

| Computation | This | | | | | | | |
|---|---|---|---|---|---|---|---|---|
| system | solution | | Qiskit | PennyLane | Tequila | | MindQuantum | |
| H₄ (8 qubits) | 0.1 | s | 34 s | 433 s | 28 | s | 1.2 | s |
| H₆ (12 qubits) | 0.4 | s | 943 s | 9,954 s | 2,141 | s | 15 | s |

| | | | | | | | |
|---|---|---|---|---|---|---|---|
| H₈ (16 qubits) | 1.9 | s | Insufficient | Insufficient | 73,978 s | 1,970 | s |

| | | | | | | |
|---|---|---|---|---|---|---|
| | | | memory | memory | (about 1 day) | |
| H₁₀ (20 | 14 | s | — | | Insufficient | 121,836 s |
| qubits) | | | | | memory | (about 2 days) |
| H₁₂ (24 | 51 | s | — | | — | >1 month |
| qubits) | | | | | | (estimated) |
| H₁₄ (28 | 2,093 | s | — | | — | — |
| qubits) | | | | | | |
| H₁₆ (32 | 50,909 | s | — | | — | — |
| qubits) | | | | | | |

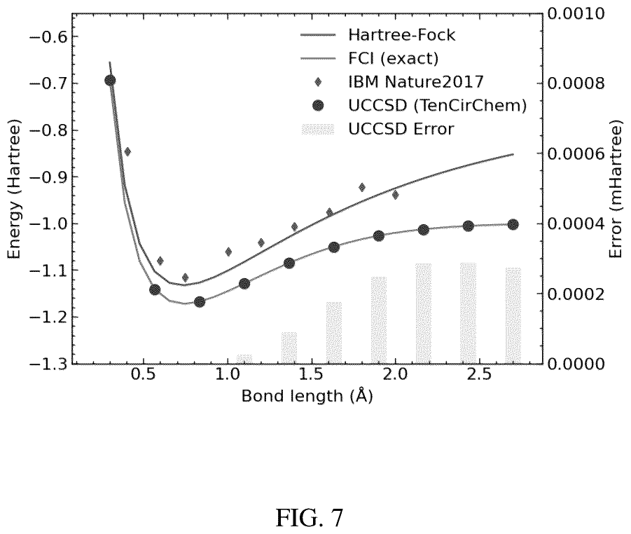

FIG. 7 shows another application example of an embodiment of the present disclosure, i.e., a potential energy surface applied to a hydrogen molecule. A basis group adopts a cc-pVTZ big basis group. The size of the system is 56 qubits. The computation result after the quantum simulation according to the embodiment of the present disclosure well fits an exact solution. From the above table, it may be seen that such a big system cannot be completely simulated by other related techniques. However, the electrons in the system are few, and correspondingly, the configurations are few, so the quantum simulation may be efficiently completed by using the embodiment of the present disclosure.

It may be seen that the computation result after the quantum simulation according to the embodiment of the present disclosure well fits an exact solution. The computation result corresponding to the embodiment of the present disclosure is UCCSD (TenCirChem), and the exact solution is full configuration interaction (FCI) (exact).

The English meanings in FIG. 7 are as follows

Energy: Molecular energy.

Hartree: The unit of energy.

Error: Mistake causing an inexact result.

Bond length: Length of bond. A with a circle on the head: The unit of the bond length, 100 μm, and angstrom.

Hartree-Fock: Classical computation approximate solution of molecular energy.

FCI (exact): Classical computation exact solution of molecular energy.

IBM Nature2017: Quantum computation results issued by IBM in 2017 on Nature, https://www.nature.com/articles/nature23879.

UCCSD (TenCirChem): Molecular energy obtained through classical simulation according to embodiments of the present disclosure.

UCCSD Error: Error of molecular energy obtained through classical simulation according to embodiments of the present disclosure.

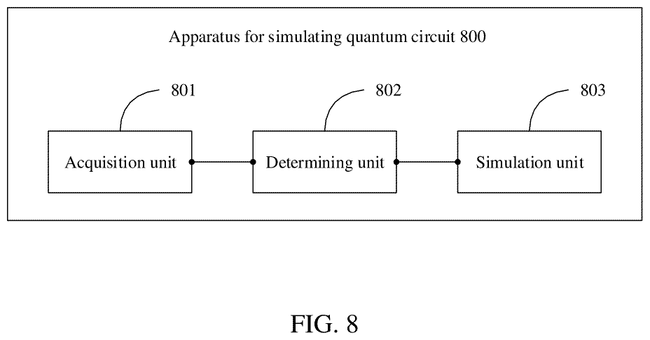

Based on embodiments corresponding to FIG. 1 to FIG. 7, FIG. 8 is an apparatus structure diagram of an apparatus for simulating a quantum circuit provided by an embodiment of the present disclosure. The apparatus for simulating a quantum circuit 800 includes an acquisition unit 801, a determining unit 802, and a simulation unit 803.

The acquisition unit 801 is configured to acquire a polynomial obtained by converting a UCC factor, an exponential part of the UCC factor including an anti-hermitian excitation operator G, and the polynomial including a linear term and quadratic term of the G.

The determining unit 802 is configured to acquire N UCC factors for representing a UCC quantum circuit to be simulated, and acquire a wave function used for representing a quantum state of an object corresponding to the UCC quantum circuit, N being an integer greater than 1.

The simulation unit 803 is configured to perform quantum simulation on the UCC quantum circuit according to the wave function and the N UCC factors to obtain a result wave function, the quantum simulation being used for performing operation in the form of the polynomial on each UCC factor and the wave function, and the result wave function being used for representing the quantum state of the object simulated via the UCC quantum circuit.

In a possible implementation, the polynomial is specifically as follows:

$${e}^{θ G} = I + ( 1 - cos θ ) {G}^{2} + sin θ G$$

In the polynomial, I is an identity matrix, e^{θG} is the UCC factor, θ is a parameter, and G is the anti-hermitian excitation operator.

The operation in the form of the polynomial on each UCC factor and the wave function is performed as follows:

$${e}^{θ G} ψ = ψ + ( 1 - cos θ ) {G}^{2} ψ + sin θ G ψ$$

In the formula, ψ is the wave function.

In a possible implementation, if the object is a chemical molecule, the G is expressed in the following form:

G=aᵢ^{†}aⱼ−aⱼ^{†}aᵢ single-excitation form, and

G=aᵢ^{†}aⱼ^{†}aₖaₗ−aₗ^{†}aₖ^{†}aⱼaᵢ double-excitation form.
in the formulas, a is a qubit, aᵢ^{†} is an operator of a particle created at an i^{th} qubit, and aⱼ is an operator of a particle annihilating at a j^{th} qubit.

In a possible implementation, the determining unit is further configured to: determine, when the object is a chemical molecule, a molecular orbital corresponding to the chemical molecule and a position combination of a position capable of being occupied by electrons of the molecule in the molecular orbital; and generate the wave function expressed in the configuration space according to the molecular orbital and the position combination.

In a possible implementation, the simulation unit is further configured to:
determine a first operation result determination mode of performing operation on the linear term of the G in the polynomial and the wave function, and a second operation result determination mode of performing operation on the quadratic term of the G and the wave function; and acquire an operation result of each UCC factor and the wave function according to the first operation result determination mode and the second operation result determination mode.

In a possible implementation, the first operation result determination mode includes once vector feature rearrangement on the wave function and once phase conversion on the wave function; and the second operation result determination mode includes once phase conversion on the wave function.

In a possible implementation, when the G is in the single-excitation form, in the first operation result determination mode, a phase parameter adopted by phase conversion is one of −1, 0, and 1, and in the second operation result determination mode, the phase parameter adopted by phase conversion is one of −1 and 0.

In a possible implementation, the quantum simulation is performed as follows:

Πᵢe^{θ}^{ᵢ}^{G}^{ᵢ}ψ

In the formula, e^{θ}^{ᵢ}^{G}^{ᵢ} is an i^{th} UCC factor, ψ is a wave function, a ψ obtained by operation of ψ with the i^{th} UCC factor is used for performing operation with the (i+1)^{th} UCC factor, and i≤N−1.

In a possible implementation, the determining unit is further configured to determine a molecular energy of the chemical molecule according to quantum states of electrons in the chemical molecule represented by the result wave function when the object is a chemical molecule.

Therefore, in order to reduce the operation complexity of quantum simulation, the polynomial obtained by converting a UCC factor in an exponential form may be acquired. Through the described conversion, the anti-hermitian excitation operator G of the exponential part in the UCC factor is converted into a linear term and a quadratic term of the G in the polynomial. According to the UCC quantum circuit to be simulated, the wave function for representing the quantum state of the object corresponding to the circuit and the N UCC factors for representing the circuit are determined. During quantum simulation on the circuit according to the wave function and the N UCC factors, operation is performed in the form of the polynomial on each UCC factor and the wave function, and the result wave function is finally obtained through quantum simulation. Through polynomial conversion, the G is converted from the exponential part to the linear term and the quadratic term. The operation complexity of the wave function and the UCC factors in quantum simulation is significantly reduced. The UCC factor can be used for quantum simulation without quantum gate decomposition. The quantum simulation efficiency is effectively improved. The effect of fast and conveniently determining the quantum state of the object corresponding to the UCC quantum circuit is achieved.

An embodiment of the present disclosure further provides a computer device. The computer device is the computer device mentioned above, and may include a terminal device or a server. The apparatus for simulating a quantum circuit may be disposed in the computer device. The computer device will be described in combination with the accompanying drawings.

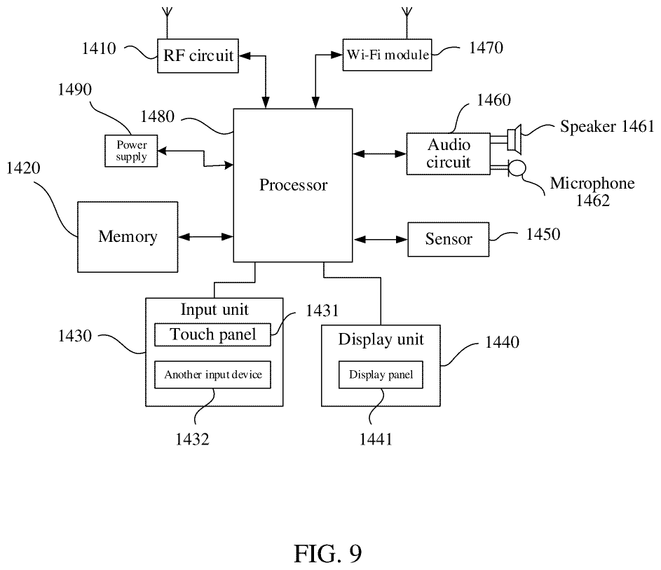

If the computer device is a terminal device, referring to FIG. 9, the embodiment of the present disclosure provides a terminal device, by taking the terminal device being a mobile phone as an example:

FIG. 9 is a block diagram of a structure of a part of a mobile phone related to the terminal device provided by an embodiment of the present disclosure. Referring to FIG. 9, the mobile phone includes: components such as a radio frequency (RF) circuit 1410, a memory 1420, an input unit 1430, a display unit 1440, a sensor 1450, an audio circuit 1460, a wireless fidelity (Wi-Fi) module 1470, a processor 1480, and a power supply 1490. A person skilled in the art may understand that the structure, shown in FIG. 9, of the mobile phone does not constitute a limitation on the mobile phone, and the mobile phone may include more or fewer components than those shown in the figure, or a combination of some components, or a different component deployment may be used.

The following specifically describes the components of the mobile phone with reference to FIG. 9.

The RF circuit 1410 may be configured to receive and transmit a signal during message reception and transmission or calling. Particularly, after receiving downlink information from a base station, the RF circuit transmits the information to the processor 1480 for processing. In addition, the RF circuit transmits related uplink data to the base station.

The memory 1420 may be configured to store a software program and a module. The processor 1480 runs the software program and the module that are stored in the memory 1420, to perform various functional applications and data processing of the mobile phone. The memory 1420 may mainly include a program storage area and a data storage area. The program storage area may store an operating system, an application program required for at least one function (for example, a sound play function and an image play function), and the like. The data storage area may store data (for example, audio data and a phone book) created based on use of the mobile phone and the like. In addition, the memory 1420 may include a high speed random-access memory, and may also include a non-volatile memory, such as at least one magnetic disk storage device, a flash memory, or another volatile solid-state storage device.

The input unit 1430 may be configured to receive inputted digit or character information, and generate a keyboard signal input related to user settings and function control of the mobile phone. Specifically, the input unit 1430 may include a touch panel 1431 and another input device 1432.

The display unit 1440 may be configured to display information inputted by the user or information provided for the user, and various menus of the mobile phone. The display unit 1440 may include a display panel 1441.

The mobile phone may further include at least one sensor 1450 such as an optical sensor, a motion sensor, and other sensors.

The audio circuit 1460, a speaker 1461, and a microphone 1462 may provide audio interfaces between the user and the mobile phone.

Wi-Fi is a short-distance wireless transmission technology. The mobile phone may help, by using a Wi-Fi module 1470, a user to receive and transmit an email, browse a web page, access stream media, and the like, to allow wireless broadband Internet access of the user.

The processor 1480 is a control center of the mobile phone, and is connected to various parts of the entire mobile phone via various interfaces and lines. The processor executes various functions of the mobile phone and performs data processing by running or executing a software program and/or a module stored in the memory 1420 and invoking data stored in the memory 1420.

The mobile phone further includes a power supply 1490 (such as a battery) for supplying power to the various components.

In the embodiment of the present disclosure, the processor 1480 included in the terminal device further has the following functions:
acquiring a polynomial obtained by converting a UCC factor, an exponential part of the UCC factor including an anti-hermitian excitation operator G, and the polynomial including a linear term and a quadratic term of the G; acquiring N UCC factors corresponding to the UCC quantum circuit to be simulated; acquiring a wave function used for representing a N quantum state of an object, N being an integer greater than 1; performing quantum simulation on the UCC quantum circuit according to the wave function and the N UCC factors, and performing operation in the form of the polynomial on each UCC factor and the wave function in the quantum simulation process; and acquiring a result wave function through the quantum simulation. The result wave function is used for simulating the quantum state of the object via the UCC quantum circuit.

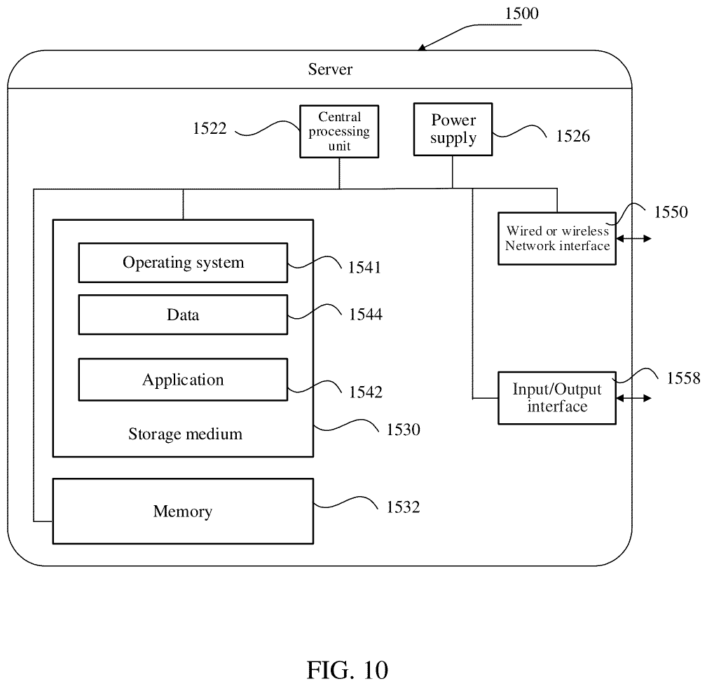

If the computer device is the server, the embodiment of the present disclosure further provides a server. Reference is made to FIG. 10. FIG. 10 is a structure diagram of a server 1500 provided by an embodiment of the present disclosure. The server 1500 may vary greatly due to different configurations or performance, and may include one or more central processing units (CPUs) 1522 (for example, one or more processors), a memory 1532, and one or more storage media 1530 (for example, one or more mass storage devices) that store application programs 1542 or data 1544. The memory 1532 and the storage medium 1530 may be used for temporary storage or persistent storage. A program stored in the storage medium 1530 may include one or more modules (not shown in the figures), and each module may include a series of instruction operations on the server. Further, the CPU 1522 may be configured to communicate with the storage medium 1530, and perform, on the server 1500, the series of instruction operations in the storage medium 1530.

The server 1500 may further include one or more power supplies 1526, one or more wired or wireless network interfaces 1550, one or more input/output interfaces 1558, and/or one or more operating systems 1541, for example, Windows Server™, Mac OS X™ Unix™, Linux™, or FreeBSD™.

Operations performed by the server in the foregoing embodiment may be based on the server structure shown in FIG. 10.

An embodiment of the present disclosure further provides a storage medium. The storage medium stores a computer program, and the computer program is used for implementing the method provided in the above embodiment.

An embodiment of the present disclosure further provides a computer program product including instructions, and the computer program product, when running on a computer, causes the computer to implement the method provided by the above embodiment.

A person of ordinary skill in the art may understand that: all or some of operations in the method embodiments may be implemented by hardware related to program instructions. The program may be stored in a computer-readable storage medium. When the program is executed, the operations of the method embodiments are performed. The above storage medium may be at least one of the followings: various media capable of storing program codes, such as a read-only memory (ROM), a random-access memory (RAM), a disk, or a disc.

The various embodiments of this specification are all described in a progressive manner, for same or similar parts in the various embodiments, reference is made to these embodiments, and descriptions of each embodiment focus on a difference from other embodiments. Especially, device and system embodiments are basically similar to the method embodiments, and therefore are described briefly; for related parts, reference may be made to partial descriptions in the method embodiments. The described device and system embodiments are merely exemplary. The units described as separate parts may or may not be physically separated, and parts displayed as units may or may not be physical units, may be located in one position, or may be distributed on a plurality of network units. Some or all of the modules may be selected according to actual needs to achieve the objectives of the solutions of the embodiments. A person of ordinary skill in the art may understand and implement the embodiments without creative efforts.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

The foregoing descriptions are merely a specific implementation of the present disclosure, but are not intended to limit the protection scope of the present disclosure. Any variation or replacement readily figured out by a person skilled in the art within the technical scope disclosed in the present disclosure shall fall within the protection scope of the present disclosure. Moreover, the present disclosure can be further combined to provide more implementations based on the implementations provided in the above aspects. Therefore, the protection scope of the present disclosure shall be subject to the protection scope of the claims.

What is claimed is:

1. A method for simulating a unitary coupled-cluster (UCC) quantum circuit, performed by a computer device, the method comprising:
acquiring a polynomial by converting a UCC factor, wherein:
an exponential part of the UCC factor comprises an anti-hermitian excitation operator G, and
the polynomial comprises a linear term of the G and a quadratic term of the G;
acquiring N UCC factors for constructing the UCC quantum circuit, N being an integer greater than 1;
acquiring a wave function for representing a quantum state of an object; and
obtaining a result wave function by performing operation in the form of the polynomial for each UCC factor in the N UCC factors on the wave function, wherein the result wave function represents the quantum state of the object after quantum simulation with the UCC quantum circuit.

2. The method according to claim 1, wherein the polynomial for each UCC factor is
$${e}^{θ G} = I + ( 1 - cos θ ) {G}^{2} + sin θ G$$
wherein: I is an identity matrix, e^{θG} is the UCC factor, θ is a parameter, and G is the anti-hermitian excitation operator; and
the operation in the form of the polynomial for each UCC factor on the wave function is performed according to
$${e}^{θ G} ψ = ψ + ( 1 - cos θ ) {G}^{2} ψ + sin θ G ψ$$
wherein ψ is the wave function.

3. The method according to claim 1, wherein when the object is a chemical molecule, the anti-hermitian excitation operator G comprises the following expression forms:
G=aᵢ^{†}aⱼ−aⱼ^{†}aᵢ single-excitation form, and
G=aᵢ^{†}aⱼ^{†}aₖaₗ−aₗ^{†}aₖ^{†}aⱼaᵢ double-excitation form; and
wherein: a is a qubit, aᵢ^{†} is an operator of a particle created at an i^{th} qubit, and aⱼ is an operator of a particle annihilating at a j^{th} qubit.

4. The method according to claim 1, wherein when the object is a chemical molecule, the wave function is determined by:
determining at least one molecular orbital corresponding to the chemical molecule and a position combination of positions capable of being occupied by electrons of the molecule in the at least one molecular orbital; and
generating the wave function expressed in a configuration space according to the at least one molecular orbital and the position combination.

5. The method according to claim 1, wherein the performing operation in the form of the polynomial for each UCC factor on the wave function comprises:
determining a first operation mode corresponding to performing operation of the linear term of the G in the polynomial on the wave function, and a second operation mode corresponding to performing operation of the quadratic term of the G on the wave function; and
acquiring an operation result of each UCC factor on the wave function according to the first operation mode and the second operation mode.

6. The method according to claim 5, wherein:
the first operation mode comprises vector feature rearrangement once on the wave function and phase conversion once on the wave function; and
the second operation mode comprises phase conversion once on the wave function.

7. The method according to claim 6, wherein, when the G is in a single-excitation form:
in the first operation mode, a phase parameter adopted by the phase conversion is one of the following: −1, 0, and 1, and
in the second operation mode, the phase parameter adopted by the phase conversion is one of the following: −1 and 0.

8. The method according to claim 1, wherein the quantum simulation is
Πᵢe^{θ}^{ᵢ}^{G}^{ᵢ}ψ
wherein: e^{θ}^{ᵢ}^{G}^{ᵢ} is an i^{th} UCC factor, θᵢ is a parameter for the i^{th} UCC factor, Gᵢ is the anti-hermitian excitation operator for the i^{th} UCC factor, ψ is the wave function, Π represents that a new ψ obtained by operation of ψ with the i^{th} UCC factor is used for performing operation with an (i+1)^{th} UCC factor, and i≤N−1.

9. The method according to claim 1, wherein when the object is a chemical molecule, the method further comprises:
determining a molecular energy of the chemical molecule according to quantum states of electrons in the chemical molecule represented by the result wave function.

10. An apparatus for simulating a unitary coupled-cluster (UCC) quantum circuit, the apparatus comprising:
a memory storing instructions; and
a processor in communication with the memory, wherein, when the processor executes the instructions, the processor is configured to cause the apparatus to perform:
acquiring a polynomial by converting a UCC factor, wherein:
an exponential part of the UCC factor comprises an anti-hermitian excitation operator G, and
the polynomial comprises a linear term of the G and a quadratic term of the G;
acquiring N UCC factors for constructing the UCC quantum circuit, N being an integer greater than 1;
acquiring a wave function for representing a quantum state of an object; and
obtaining a result wave function by performing operation in the form of the polynomial for each UCC factor in the N UCC factors on the wave function, wherein the result wave function represents the quantum state of the object after quantum simulation with the UCC quantum circuit.

11. The apparatus according to claim 10, wherein the polynomial for each UCC factor is
$${e}^{θ G} = I + ( 1 - cos θ ) {G}^{2} + sin θ G$$
wherein: I is an identity matrix, e^{θG} is the UCC factor, θ is a parameter, and G is the anti-hermitian excitation operator; and
the operation in the form of the polynomial for each UCC factor on the wave function is performed according to
$${e}^{θ G} ψ = ψ + ( 1 - cos θ ) {G}^{2} ψ + sin θ G ψ$$
wherein ψ is the wave function.

12. The apparatus according to claim 10, wherein when the object is a chemical molecule, the anti-hermitian excitation operator G comprises the following expression forms:
G=aᵢ^{†}aⱼ−aⱼ^{†}aᵢ single-excitation form, and
G=aᵢ^{†}aⱼ^{†}aₖaₗ−aₗ^{†}aₖ^{†}aⱼaᵢ double-excitation form; and
wherein: a is a qubit, aᵢ^{†} is an operator of a particle created at an i^{th} qubit, and aⱼ is an operator of a particle annihilating at a j^{th} qubit.

13. The apparatus according to claim 10, wherein when the object is a chemical molecule, the wave function is determined by:
determining at least one molecular orbital corresponding to the chemical molecule and a position combination of positions capable of being occupied by electrons of the molecule in the at least one molecular orbital; and
generating the wave function expressed in a configuration space according to the at least one molecular orbital and the position combination.

14. The apparatus according to claim 10, wherein, when the processor is configured to cause the apparatus to perform performing operation in the form of the polynomial for each UCC factor on the wave function, the processor is configured to cause the apparatus to perform:
determining a first operation mode corresponding to performing operation of the linear term of the G in the polynomial on the wave function, and a second operation mode corresponding to performing operation of the quadratic term of the G on the wave function; and
acquiring an operation result of each UCC factor on the wave function according to the first operation mode and the second operation mode.

15. The apparatus according to claim 14, wherein:
the first operation mode comprises vector feature rearrangement once on the wave function and phase conversion once on the wave function; and
the second operation mode comprises phase conversion once on the wave function.

16. The apparatus according to claim 15, wherein, when the G is in a single-excitation form:
in the first operation mode, a phase parameter adopted by the phase conversion is one of the following: −1, 0, and 1, and
in the second operation mode, the phase parameter adopted by the phase conversion is one of the following: −1 and 0.

17. The apparatus according to claim 10, wherein the quantum simulation is
Πᵢe^{θ}^{ᵢ}^{G}^{ᵢ}ψ
wherein: e^{θ}^{ᵢ}^{G}^{ᵢ} is an i^{th} UCC factor, θᵢ is a parameter for the i^{th} UCC factor, Gᵢ is the anti-hermitian excitation operator for the i^{th} UCC factor, ψ is the wave function, Π represents that a new ψ obtained by operation of ψ with the i^{th} UCC factor is used for performing operation with an (i+1)^{th} UCC factor, and i≤N−1.

18. The apparatus according to claim 10, wherein when the object is a chemical molecule, the processor is configured to further cause the apparatus to perform:
determining a molecular energy of the chemical molecule according to quantum states of electrons in the chemical molecule represented by the result wave function.

19. A non-transitory computer-readable storage medium, storing computer-readable instructions for simulating a unitary coupled-cluster (UCC) quantum circuit, wherein, the computer-readable instructions, when executed by a processor, are configured to cause the processor to perform:
acquiring a polynomial by converting a UCC factor, wherein:
an exponential part of the UCC factor comprises an anti-hermitian excitation operator G, and
the polynomial comprises a linear term of the G and a quadratic term of the G;
acquiring N UCC factors for constructing the UCC quantum circuit, N being an integer greater than 1;
acquiring a wave function for representing a quantum state of an object; and
obtaining a result wave function by performing operation in the form of the polynomial for each UCC factor in the N UCC factors on the wave function, wherein the result wave function represents the quantum state of the object after quantum simulation with the UCC quantum circuit.

20. The non-transitory computer-readable storage medium according to claim 19, wherein the polynomial for each UCC factor is
$${e}^{θ G} = I + ( 1 - cos θ ) {G}^{2} + sin θ G$$
wherein: I is an identity matrix, e^{θG} is the UCC factor, θ is a parameter, and G is the anti-hermitian excitation operator; and
the operation in the form of the polynomial for each UCC factor on the wave function is performed according to
$${e}^{θ G} ψ = ψ + ( 1 - cos θ ) {G}^{2} ψ + sin θ G ψ$$
wherein ψ is the wave function.
